(19) United States
(12) Patent Application Publication
(10) Pub. No.: US 2026/0296137 A1
(43) Pub. Date: Oct. 1, 2026

(54) AIR-CONDITIONING OUTLET DEVICE FOR VEHICLE

(71) Applicants: TOYO DENSO KABUSHIKI KAISHA, Tokyo (JP); HONDA MOTOR CO., LTD., Tokyo (JP)

(72) Inventors: Yuki Ota, Tsurugashima-shi (JP); Yusuke Kii, Tsurugashima-shi (JP); Kenta Watanabe, Tsurugashima-shi (JP); Naoto Nishi, Tokyo (JP)

(73) Assignees: TOYO DENSO KABUSHIKI KAISHA, Tokyo (JP); HONDA MOTOR CO., LTD., Tokyo (JP)

(21) Appl. No.: 19/549,090

(22) Filed: Feb. 25, 2026

(30) Foreign Application Priority Data
Mar. 31, 2025 (JP) 2025-057833

(51) Int. Cl. B60H 1/00

(52) U.S. Cl. CPC B60H 1/00871; B60H 1/00735

(57) ABSTRACT

The air conditioning outlet device (1) for a vehicle includes at least one air-conditioning outlet (2) and a control unit (3) that controls the air-conditioning outlet (2). The air-conditioning outlet (2) includes a driving unit (11, 12) and a wind direction adjustment fin (13, 14) that is driven by the driving unit (11, 12). The control unit (3) performs shut control to move the fin (14) of the at least one air-conditioning outlet (2) to a fully closed position when wind blowing is stopped during an operation of air-conditioning of the vehicle, and air-conditioning stop control to move the fins (14) of all of the air-conditioning outlets (2) to an air-conditioning stop position which is a position with a gap from the fully closed position when the air-conditioning is stopped.

### CROSS-REFFERENCE TO RELATED APPLICATIONS

This application is based on and claims the benefit of priority from Japanese Patent Application No. 2025-057833 filed in Japan on Mar. 31, 2025, the contents of which are hereby incorporated by reference in their entirety.

### BACKGROUND OF THE INVENTION

### Field of the Invention

The present invention relates to an air-conditioning outlet device for a vehicle.

### Description of Related Art

Conventionally, a control method is known in which wind direction adjustment fins of an air-conditioning outlet of an automobile are rotated by a motor. For example, for reasons (1) and (2) below, when the air-conditioning is stopped, the fins are stopped at a fully closed position so that the fins are moved to a position at which it is difficult for occupants’ hands (fingers) to reach, and when the air-conditioning is operating, the fins are controlled to return to an original wind direction position thereof.
(1) To prevent the fins from moving to an unintended position due to tampering by the occupants when parking.
(2) To prevent foreign objects from entering through the air-conditioning outlet.

Furthermore, to simplify a configuration, an operation (a shutoff operation) in which wind blowing is stopped by the fins is performed.

A technology in which wind direction adjustment fins of an air-conditioning outlet of an automobile are rotated by driving a motor is known. As an example of such a technology, Patent Document 1 discloses a motor unit for driving opening and closing of louvers disposed in a ventilation hole of an automobile. In Patent Document 1, when an air conditioner or ignition of an automobile is turned off, the louvers are stopped at a fully closed position, and when the air conditioner is turned on again, the louvers are opened from the fully closed position and automatically returned to a set position.

There is also known a technology in which the fins of an automobile air-conditioning outlet have both an air direction adjustment function and a shutoff function (a function to stop the air from being blown out). As an example of such technology, Patent Document 2 discloses a configuration including an air duct mounted in an instrument panel of an automobile, a wind direction deflecting plate disposed inside the front of the air duct, and a rear wind direction deflecting plate disposed inside the rear of the air duct that also serves as a shut damper. In Patent Document 2, a sealing member is provided between the rear wind direction deflecting plate and an inner circumferential surface of the air duct.

### Patent Documents

Patent Document 1 Japanese Unexamined Patent Application, First Publication No. 2001-246924

Patent Document 2 Japanese Unexamined Patent Application, First Publication No. 2001-280683

### SUMMARY OF THE INVENTION

However, in the case in which the louvers, deflecting plates (fins), or the like are stopped at the fully closed position when the automobile is parked, due to a high temperature environment during parking in the summer, deformation and deterioration of soft materials such as the sealing members and the fins themselves can occur. Therefore, there was room for improvement in terms of increasing options for soft materials and materials for forming fins.

In order to solve the above problems, an object of the present application is to provide an air-conditioning outlet device for a vehicle capable of preventing deformation and deterioration of soft materials such as sealing members and the fins themselves, and increasing options for soft materials and materials for forming fins.

As a means for solving the above problems, the present invention has the following configuration.

(1) An air-conditioning outlet device for a vehicle according to one aspect of the present invention includes at least one air-conditioning outlet, and a control unit configured to control the air-conditioning outlet, wherein the air-conditioning outlet includes a driving unit and a wind direction adjustment fin that is driven by the driving unit, and the control unit performs shut control to move the fin of the at least one air-conditioning outlet to a fully closed position when wind blowing is stopped during an operation of air-conditioning of the vehicle, and air-conditioning stop control to move the fins of all of the air-conditioning outlets to an air-conditioning stop position which is a position with a gap from the fully closed position when the air-conditioning is stopped.

According to the aspect, when the air-conditioning is turned off, the fins of all air-conditioning outlets are stopped with a gap from the fully closed position, and thus it is possible to curb deformation and deterioration of soft materials such as sealing members and the fins themselves, which may be caused by a high temperature environment during parking in the summer. Therefore, it is possible to increase options for soft materials and materials for forming the fins.

(2) The air-conditioning outlet device for a vehicle may further include a sealing member at a portion of the fin that faces the gap.

(3) In the air-conditioning outlet device for a vehicle, when the air-conditioning stop control is performed, the control unit may move the fins to the fully closed position to align them with origin positions, then move them to the air-conditioning stop position, and stop them.

(4) In the air-conditioning outlet device for a vehicle, the air-conditioning stop position may be a position between a limit position on a side close to the fully closed position and the fully closed position within a wind direction adjustment range of the fins.

(5) In the air-conditioning outlet device for a vehicle, the gap may be a gap that prevents spheres with a diameter of 5 mm or more from entering.

(6) In the air-conditioning outlet device for a vehicle, the fins may be configured in two axes in the air-conditioning outlet, the fins configured in two axes may include windward fins and leeward fins disposed downstream of the windward fin in a wind direction, and the control unit may perform the shut control and the air-conditioning stop control on the leeward fins.

According to one aspect of the present invention, deformation and deterioration of soft materials such as sealing members and the fins themselves can be prevented, and options for soft materials and materials for forming fins can be increased.

### BRIEF DESCRIPTION OF THE DRAWINGS

FIG. 1 is a perspective view showing an overview of an air-conditioning outlet device for a vehicle according to an embodiment.

FIG. 2 is a front view showing an overview of an air-conditioning outlet according to the embodiment.

FIG. 3 is a cross-sectional view along line III-III in FIG. 2 and shows a range of movement of a leeward fin.

FIG. 4 is a cross-sectional view along line IV-IV in FIG. 2 and shows a range of movement of a windward fin.

FIG. 5 is a diagram showing a position of wind direction adjustment fins when wind is blown toward a center in the embodiment.

FIG. 6 is a diagram showing the position of the wind direction adjustment fins when wind blowing is stopped in the embodiment.

FIG. 7 is a diagram showing the position of the wind direction adjustment fins when air-conditioning is stopped in the embodiment.

FIG. 8 is a diagram explaining an example of an operation of the wind direction adjustment fins when the air-conditioning is stopped in the embodiment.

### DETAILED DESCRIPTION OF THE INVENTION

Hereinafter, an embodiment of the present invention will be described with reference to the drawings. In the following description, expressions indicating relative or absolute arrangement, such as “parallel,” “orthogonal,” “center,” and “coaxial,” do not only mean such an arrangement strictly, but also include a state in which there is a relative displacement with a tolerance or an angle or distance to an extent that the same function is obtained. In the drawings used in the following description, a scale of each component has been changed appropriately so that each component can be recognized.

### Air-conditioning outlet device for vehicle

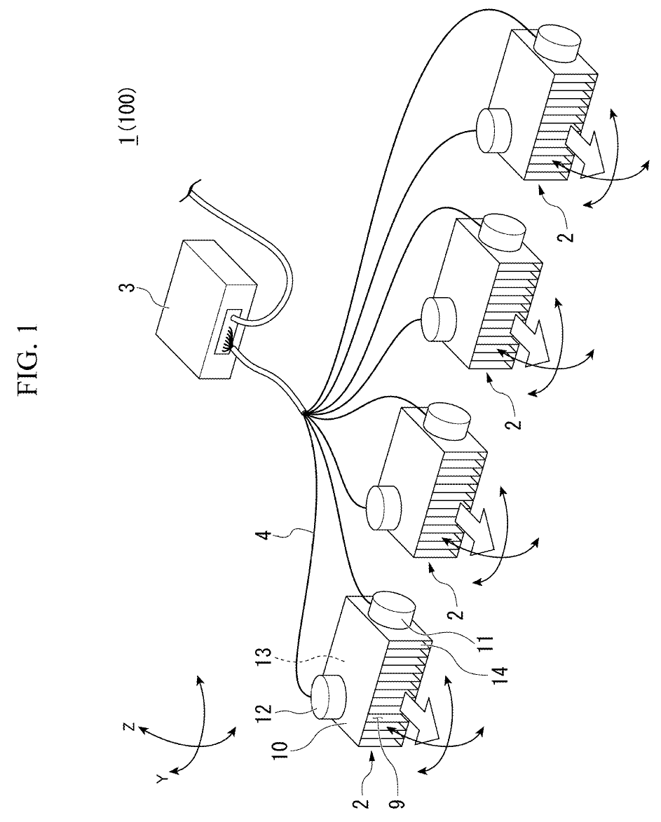

FIG. 1 is a perspective view showing an overview of an air-conditioning outlet device 1 for a vehicle according to an embodiment.

As shown in FIG. 1, the air-conditioning outlet device 1 for a vehicle includes at least one air-conditioning outlet 2 and a control unit 3 that controls the air-conditioning outlet 2. In the following description, unless otherwise specified, directions such as up, down, front, back, left, and right are the same as those in a vehicle 100 in which the air-conditioning outlet device 1 for a vehicle is mounted.

The air-conditioning outlet device 1 for a vehicle is provided, for example, in an instrument panel or the like of the vehicle 100. In the example of FIG. 1, four air-conditioning outlets 2 are disposed. For example, the four air-conditioning outlets 2 may be disposed one on the left end side, one on the left side of a center, one on the right side of the center, and one on the right end side at a front portion of the vehicle. The arrangement (location and number) of the air-conditioning outlets 2 is not limited to the above and can be changed according to design specifications.

### Air-conditioning outlet

The air-conditioning outlet 2 includes driving units 11 and 12 and wind direction adjustment fins 13 and 14 which are driven by the driving units 11 and 12.

The air-conditioning outlet 2 includes a duct 10 that forms an opening 9. The duct 10 is formed in a tubular shape in a wind direction. In the example of FIG. 1, the duct 10 is formed in the shape of a rectangular box that opens in a direction in which wind blows out. The shape of the duct 10 is not limited to the above and can be changed according to design specifications.

The driving units 11 and 12 are mounted on the duct 10. In the example of FIG. 1, the driving units 11 and 12 are mounted on an upper surface and a side surface of the duct 10, respectively. The driving units 11 and 12 include a side driving unit 11 mounted on the side surface of the duct 10 and an upper driving unit 12 mounted on the upper surface of the duct 10. Mounting positions of the driving units 11 and 12 are not limited to those described above and can be changed according to design specifications.

The driving units 11 and 12 are connected to the control unit 3 via, for example, a wiring 4 or the like. Each of the driving units 11 and 12 includes a driving motor such as a stepping motor. The driving units 11 and 12 may include a power source other than a motor. The configuration of the driving units 11 and 12 is not limited to the above and can be changed according to design specifications.

Each of the fins 13 and 14 is disposed near the opening 9 of the duct 10. The fin 13 of the embodiment has a function of adjusting a wind direction. The fin 14 of the embodiment has both a function of adjusting a wind direction and a shut function (a function of stopping wind blowing).

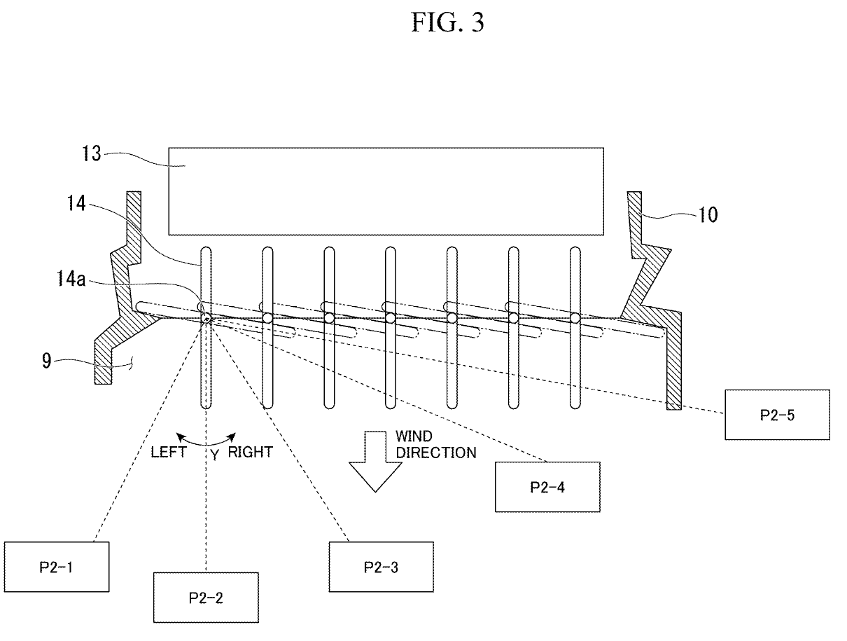

The fins 13 and 14 are formed of, for example, a resin or the like. When wind blowing is stopped during an air-conditioning operation of the vehicle 100, the fins 14 are moved to a fully closed position (for example, a fully closed position P2-5 of the leeward fin 14 shown in FIG. 3). In the following description, the fully closed position P2-5 of the fins 14 may be simply referred to as a “fully closed position.” This fully closed position corresponds to a state in which an air-conditioning system of the vehicle 100 blows air, but the fins 14 close the opening 9 so that wind does not come out of the opening 9.

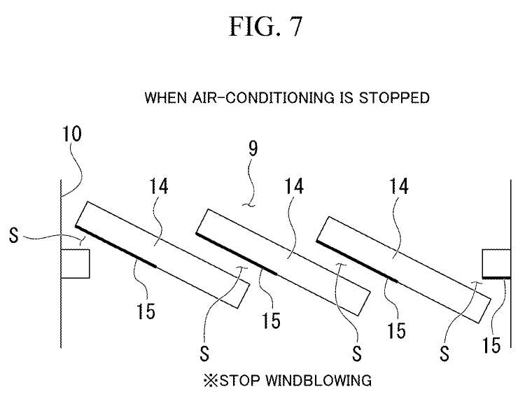

When the air-conditioning of the vehicle is stopped, the fins 14 are stopped with a gap S (refer to FIG. 7) from the fully closed position.

### Configuration of wind direction adjustment fins

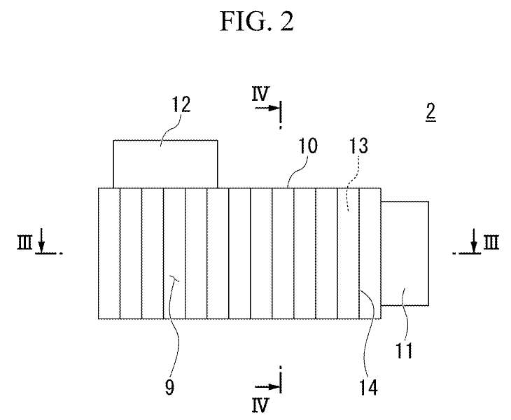

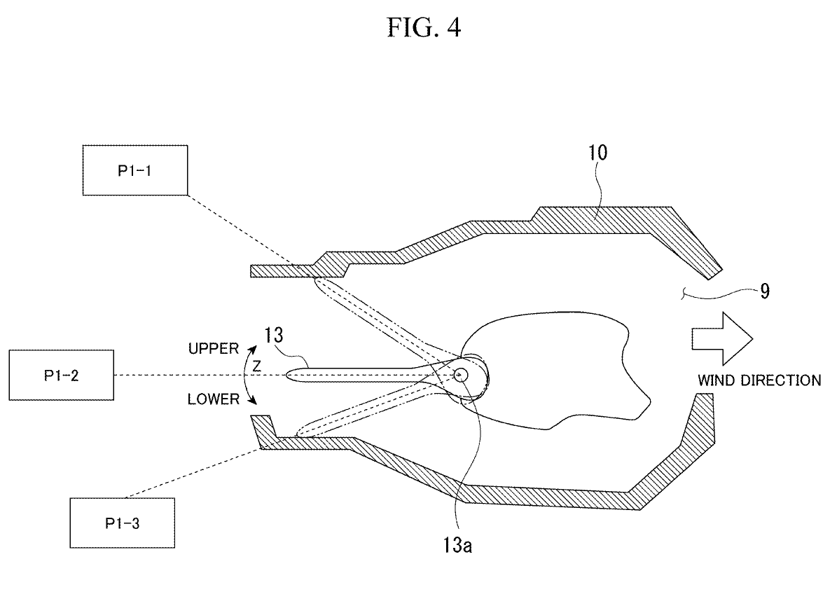

FIG. 2 is a front view showing an overview of the air-conditioning outlet 2 according to the embodiment. FIG. 3 is a cross-sectional view taken along line III-III in FIG. 2 and shows a range of movement of the leeward fins 14. FIG. 4 is a cross-sectional view taken along line IV-IV in FIG. 2 and shows the range of movement of the windward fin 13.

Referring also to FIGS. 2 to 4, in the air-conditioning outlet 2, the fins 13 and 14 are configured along two axes. The fins 13 and 14 configured in two axes include a windward fin 13 and a leeward fin 14 that is disposed downstream of the windward fin 13 in the wind direction.

### Windward Fin

Referring to FIGS. 1 and 4, the windward fin 13 is disposed inside the duct 10 upstream of the leeward fins 14 in the wind direction. The windward fin 13 is rotatable about a first axis 13a that extends in a lateral direction (for example, a vehicle width direction, corresponding to a horizontal direction).

The windward fin 13 is rotatable up and down (in a direction of an arrow Z in the drawing) around the first axis 13a. The windward fin 13 is rotated by the side driving unit 11 (refer to FIG. 1) on the side surface of the duct 10 via a mechanism (for example, a reduction mechanism or the like) which is not shown. The windward fin 13 is rotatable between an upper wind direction limit position P1-1 and a lower wind direction limit position P1-3.

The upper wind direction limit position P1-1 of the windward fin 13 is a position when a tip end portion of the windward fin 13 (an end portion on the upstream side in the wind direction) comes into contact with an upper surface of an inner circumference of the duct 10 and is a position at which the windward fin 13 stops when the wind direction is directed most upward. An up-down wind direction center position P1-2 of the windward fin 13 is a position when the tip end portion of the windward fin 13 is on an up-down central plane (corresponding to a horizontal plane) in an opening direction of the duct 10, and is a position at which the windward fin 13 stops when the wind direction is directed toward the center. The lower wind direction limit position P1-3 of the windward fin 13 is a position when the tip end portion of the windward fin 13 comes into contact with a lower surface of the inner circumference of the duct 10 and is a position at which the wind stops when the wind direction is directed most downward. The wind direction in the up-down direction can be adjusted by stopping or rotating the windward fin 13 at a constant speed between the upper wind direction limit position P1-1 and the lower wind direction limit position P1-3 to reciprocate therebetween.

### Leeward fin

Referring to FIGS. 1 and 3, the leeward fin 14 is disposed inside the duct 10 downstream of the windward fin 13 in the wind direction. The leeward fin 14 is rotatable around a second axis 14a that extends in a longitudinal direction (corresponding to, for example, an up-down direction of the vehicle, a vertical direction). A plurality of (seven in the example of FIG. 3) leeward fins 14 are arranged and disposed in the lateral direction. The plurality of leeward fins 14 are disposed at equal intervals on the left and right sides at a fully open position. The plurality of leeward fins 14 are connected together by a connecting member (not shown) to be rotatable together. The plurality of leeward fins 14 are formed in a plate shape having a size that allows them to close an air passage in the duct 10 at the fully closed position.

The leeward fins 14 are rotatable left and right (in the direction of the arrow Y in the drawing) around second axes 14a. The leeward fins 14 are rotated by the upper driving unit 12 (refer to FIG. 1) on the upper surface of the duct 10 via a mechanism (for example, a reduction mechanism) (not shown). The leeward fins 14 are rotatable between a left wind direction limit position P2-1 and the fully closed position P2-5.

A left-right wind direction center position P2-2 of the leeward fins 14 is a position when a tip end portion of each of the leeward fins 14 is on a plane (corresponding to a vertical plane) in the opening direction of the duct 10, and is a position where the leeward fins 14 stop when the wind direction is directed toward the center. A left wind direction limit position P2-1 of the leeward fins 14 is a position at which the leeward fins 14 face leftward from the left-right wind direction center position P2-2 and is a position at which the leeward fins 14 stop when the wind direction is directed to the farthest left. A right wind direction limit position P2-3 of the leeward fins 14 is a position at which the leeward fins 14 face rightward from the left-right wind direction center position P2-2 and is a position at which the leeward fins 14 stop when the wind direction is directed to the farthest right. The wind direction in the left-right direction can be adjusted by stopping or rotating the leeward fins 14 at a constant speed between the left wind direction limit position P2-1 and the right wind direction limit position P2-3 to reciprocate therebetween. The fully closed position P2-5 of the leeward fins 14 is a position at which the tip end portion of the rightmost leeward fin 14 comes into contact with a right surface of the inner circumference of the duct 10 and the leeward fins 14 adjacent to each other partially comes into contact with each other, and is a position at which the leeward fins 14 stop when the wind blowing is stopped during the air-conditioning operation. When the leeward fins 14 are stopped at the fully closed position P2-5, the wind blowing from the air conditioner to the opening 9 is blocked. An air-conditioning stop position P2-4 of the leeward fins 14 is between the right wind direction limit position P2-3 and the fully closed position P2-5 and is a position at which there is a gap S (refer to FIG. 7) to prevent the leeward fins 14 from coming into contact with each other or the leeward fins 14 from coming into contact with the inner circumference of the duct 10 and is a position at which the leeward fins 14 stop when the air-conditioning is stopped. By stopping the leeward fins 14 at the air-conditioning stop position P2-4, it is possible to prevent a sealing member described below from being crushed and the leeward fins 14 from being subjected to stress.

### Sealing Member

The air-conditioning outlet 2 may include a sealing member 15 (refer to FIG. 7) at a portion of the fin 14 that faces the gap S. The sealing member 15 may be formed, for example, of a material softer than the fin 14. Examples of the material for the sealing member 15 include elastomer materials, nonwoven fabrics, soft sheets, and the like. The material for the sealing member 15 is not limited to the above and can be changed according to design specifications.

The sealing member 15 may be formed, for example, to cover an outer peripheral edge of each of the fins 14. The sealing member 15 may be formed, for example, to cover at least portions of the adjacent fins 14 that face each other when the fins 14 are at the fully closed position. The sealing member 15 may be formed, for example, at a portion of the inner circumferential surface of the duct 10 that faces the fins 14 at the fully closed position. The manner in which the sealing member 15 is formed is not limited to the above and can be changed according to design specifications. By providing the sealing member 15, it is possible to curb wind leakage into the opening 9 when the fins 14 are moved to the fully closed position while wind blowing is stopped during the air-conditioning operation.

### Control unit

In the embodiment, a plurality of air-conditioning outlets 2 are controlled by a single separate control unit 3. In the example shown in FIG. 1, one control unit 3 is provided for four air-conditioning outlets 2. The control unit 3 controls the driving units 11 and 12 of each of the air-conditioning outlets 2 by wire, for example, via the wiring 4. The control unit 3 may also control the driving units 11 and 12 by wireless communication without via the wiring 4. The configuration of the control unit 3 is not limited to the above and can be changed according to design specifications.

Although not shown, the control unit 3 includes an operational unit and a storage unit. For example, the operational unit is configured of a processor such as a central processing unit (CPU). For example, the storage unit includes a read only memory (ROM) for storing programs, a random access memory (RAM) for temporarily storing data, a flash memory, and the like.

When the wind blowing from any of the air conditioning outlets 2 is stopped during the air-conditioning operation of the vehicle, the control unit 3 moves the fins 14 of the corresponding air conditioning outlet 2 to the fully closed position (shut control). When the air-conditioning is stopped, the control unit 3 moves the fins 14 of all the air-conditioning outlets 2 from the fully closed position to the air-conditioning stop position which is a position with the gap S (air-conditioning stop control).

For example, when air-conditioning is in operation and the wind blowing from the rightmost air-conditioning outlet 2 shown in FIG. 1 is to be stopped, the control unit 3 moves the fins 14 of the rightmost air-conditioning outlet 2 to the fully closed position. Further, when air-conditioning is stopped, the control unit 4 moves the fins 14 of all four air-conditioning outlets 2 from the fully closed position to the air-conditioning stop position which is a position with the gap S.

In the embodiment, when the air-conditioning stop control is performed on the leeward fins 14 (the fins inside a passenger compartment), the fins 14 can be stopped in a position that is difficult for the occupants’ hands (fingers) to reach when the air-conditioning is stopped, and thus the fins 14 can be prevented from being moved to an unintended position due to tampering. Furthermore, since the fins 14 do not come into contact with each other or with the inner circumference of the duct 10, deformation and deterioration of soft materials such as sealing members and the fins themselves caused by high temperature environments during parking in the summer can be prevented.

Furthermore, when the control unit 3 performs the air-conditioning stop control, first, the control unit 3 may move the fins 14 to the fully closed position to align them with origin positions, and then move them to the air-conditioning stop position to stop them. By first moving the fins 14 to the fully closed position and aligning them with the origin positions, the fins 14 can be accurately moved to the air-conditioning stop position and then stopped.

An amount of movement of the fins 14 from the fully closed position to the air-conditioning stop position is set based on variation factors of parts associated with the fins 14. The parts associated with the fins 14 include the fins 14 themselves, the duct 10, the sealing member 15, an axis member (the second axis 14a shown in FIG. 3) that rotatably supports the fins 14, a mechanism not shown, the control unit 3, and the like. For example, the amount of movement (a minimum distance between the fins and the surrounding parts) is set to an amount that takes into consideration an amount of crushing of the sealing member 15, play in the mechanism, backlash of the motor, and an amount of deviation in software control (deviation on the control side). The amount of deviation in software control may be, for example, an error or variation in control resolution of an rotation angle of the motor.

### Position of wind direction adjustment fins

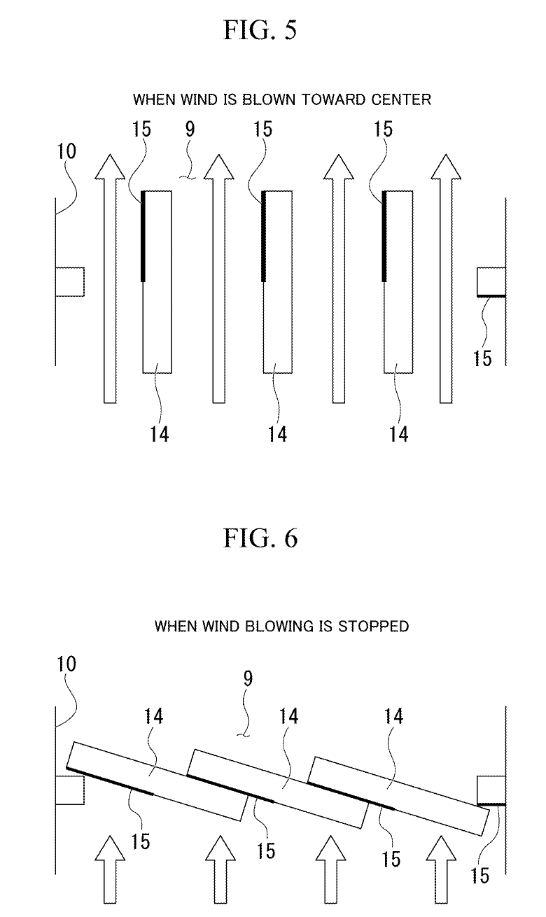

FIG. 5 shows a position of the wind direction adjustment fins when wind is blown toward a center according to the embodiment. FIG. 6 shows the position of the wind direction adjustment fins when wind blowing is stopped according to the embodiment. FIG. 7 is a diagram showing the position of the wind direction adjustment fins when the air-conditioning is stopped according to the embodiment. FIGS. 5 to 7 show examples of a plurality of (three in the illustrated example) leeward fins 14 provided with the sealing members 15 as the wind direction adjustment fins.

As shown in FIG. 5, when wind is blown toward the center, each of the plurality of leeward fins 14 is disposed on a plane (corresponding to a vertical plane) in the opening direction of the duct 10. The position shown in FIG. 5 corresponds to the left-right wind direction center position P2-2 of the leeward fins 14 shown in FIG. 3. When wind is blown toward the center as shown in FIG. 5, the wind passes between the plurality of leeward fins 14 and is blown out of the opening 9 in the direction of the arrow.

As shown in FIG. 6, when wind blowing is stopped, each of the plurality of leeward fins 14 is disposed so that the adjacent leeward fins 14 come into contact with each other or with a side surface (a wall portion) of the inner circumference of the duct 10. The position shown in FIG. 6 corresponds to the fully closed position P2-5 of the leeward fins 14 shown in FIG. 3. When wind blowing is stopped as shown in FIG. 6, the plurality of leeward fins 14 block the wind blowing from the opening 9 in the direction of the arrow.

As shown in FIG. 7, when air-conditioning is stopped, each of the plurality of leeward fins 14 is stopped with the gap S from the fully closed position. The position shown in FIG. 7 corresponds to the air-conditioning stop position P2-4 shown in FIG. 3. When the air-conditioning is stopped as shown in FIG. 7, the wind blowing from the air-conditioning device is stopped, and thus even when the gap S is formed, no wind is blown out of the opening 9.

From the viewpoint of preventing intrusion of foreign matter, it is desirable that the gap S be the minimum necessary, for example, a gap that does not allow a sphere with a diameter of 5 mm or more to enter.

### Operation of wind direction adjustment fins when air-conditioning is stopped

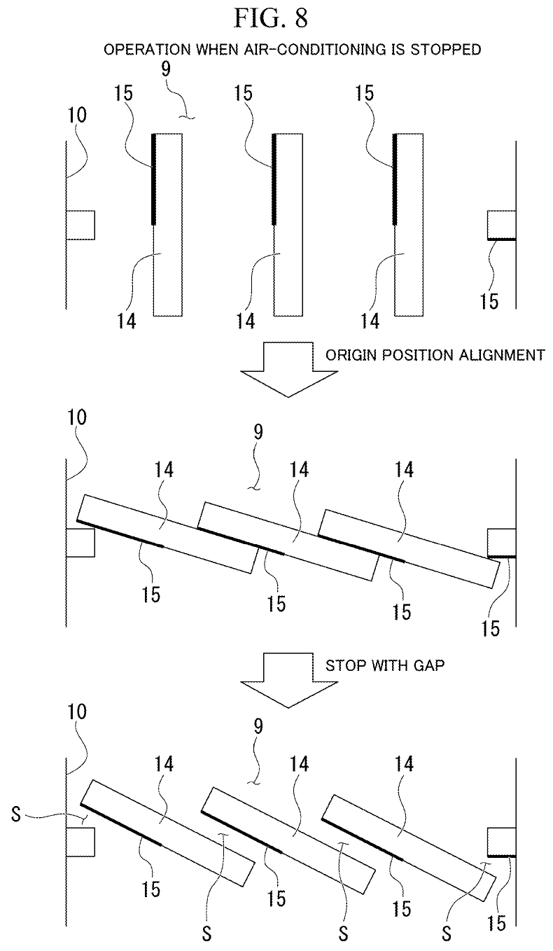

FIG. 8 shows an example of an operation (a control method) of the wind direction adjustment fins when air-conditioning is stopped according to an embodiment. In the example of FIG. 8, a plurality of (three in the example shown) leeward fins 14 with sealing members 15 are provided as the wind direction adjustment fins.

In the example of FIG. 8, when air-conditioning is stopped, the control unit 3 first aligns the plurality of leeward fins 14 with the origin positions. As the origin position alignment, the control unit 3 temporarily moves the plurality of leeward fins 14 to the fully closed position. In this fully closed position, each of the plurality of leeward fins 14 is disposed so that the adjacent leeward fins 14 come into contact with each other or with the side surface (the wall portion) of the inner circumference of the duct 10 via the sealing member 15.

Next, the control unit 3 moves the plurality of leeward fins 14 to a position at which the gap S is formed and then stops them. That is, the control unit 3 aligns the plurality of leeward fins 14 with the origin positions at the fully closed position P2-5 shown in FIG. 3, and then moves them to the air-conditioning stop position P2-4 shown in FIG. 3. At the air-conditioning stop position P2-4, the leeward fins 14 including the sealing members 15 are stopped with the gap S.

For example, when the driving unit 12 is configured of a stepping motor, the origin position alignment of the leeward fins 14 may be performed by repeating step-out at the fully closed position. Furthermore, when the step-out is detected, it may be determined that the fully closed position has been reached, and the origin position alignment may be performed. Alternatively, the origin position alignment may be performed by detecting the fully closed position using a sensor or a mechanical switch.

### Effects

As described above, the air-conditioning outlet device 1 for a vehicle of the embodiment includes at least one air-conditioning outlet 2 and the control unit 3 that controls the air-conditioning outlet 2. The air-conditioning outlet 2 includes the driving units 11 and 12 and the wind direction adjustment fins 13 and 14 which are driven by the driving units 11 and 12. The control unit 3 performs the shut control to move the fins 14 of at least one air-conditioning outlet 2 to the fully closed position when wind blowing is stopped during the operation of the air-conditioning of the vehicle, and the air-conditioning stop control to move the fins 14 of all the air-conditioning outlets 2 from the fully closed position to the position at which the gap S is formed, that is, the air-conditioning stop position, when the air-conditioning is stopped.

With this configuration, since the fins 14 do not come into contact with each other or with the inner circumference of the duct 10 when the air-conditioning is stopped, it is possible to prevent deformation and deterioration of soft materials such as sealing members and the fins themselves due to high temperature environments during parking in the summer. This allows for more options for soft materials and materials for forming the fins.

In the embodiment, the fins 14 are further provided with the sealing members 15 at the portions that faces the gaps S.

With this configuration, the sealing members 15 can curb wind leaking into the openings 9 when wind blowing is stopped.

In the embodiment, when the control unit 3 performs the air-conditioning stop control, first, the control unit 3 moves the fins 14 to the fully closed position to align them with the origin positions, then moves them to the air-conditioning stop position, and stops them.

With this configuration, by first moving the fins 14 to the fully closed position and aligning the fins 14 with the origin positions, the fins 14 can be accurately moved to the air-conditioning stop position and stopped there.

In the embodiment, the air-conditioning stop position is a position within a wind direction adjustment range of the fins 14 between the limit position closest to the fully closed position and the fully closed position.

With this configuration, the air-conditioning stop position is close to the fully closed position and can make it possible to narrow the gap S. Thus, it is possible to prevent foreign matter from entering through the gap S.

In the embodiment, the gap S is a gap that prevents spheres with a diameter of 5 mm or more from entering.

With this configuration, it is possible to prevent foreign matter from entering through the gap S when the air-conditioning is stopped.

In the embodiment, the fins in the air-conditioning outlet are configured with two axes. The two-axis fins include the windward fins and the leeward fins disposed downstream in the wind direction from the windward fins. The control unit performs the shut control and the air-conditioning stop control on the leeward fins.

With this configuration, when the air-conditioning stop control is performed on the leeward fins 14 (the fins inside the passenger compartment), the fins 14 can be stopped at a position that is difficult for occupants’ hands (fingers) to reach when the air-conditioning is stopped, and it is possible to prevent the fins 14 from being moved to an unintended position due to tampering.

### Modified example

In the embodiment, the example has been described in which a sealing member was further provided in the portion of the fin facing the gap, but the present invention is not limited thereto. For example, in cases in which wind leakage into the opening can be prevented by increasing a contact area between the fins or a contact area between the fins and the inner circumference of the duct, it is not necessary to provide a sealing member on the portion of the fin that faces the gap. An installation mode of the sealing member can be changed according to design specifications.

In the embodiment, the example has been given in which, when the air-conditioning stop control is performed, the control unit first moves the fins to the fully closed position to align them with the origin potions, then moves them to the air-conditioning stop position, and stops them, but the present invention is not limited thereto. For example, when the air-conditioning stop control is performed, the control unit may move the fins to the air-conditioning stop position from the beginning and stop them there without first moving them to the fully closed position (the origin positions). The manner in which the fins are stopped with a gap from the fully closed position when the air-conditioning is stopped can be changed according to design specifications.

In the embodiment, the example has been described in which the air-conditioning stop position is a position between the limit position closest to the fully closed position and the fully closed position within the wind direction adjustment range of the fins, but the present invention is not limited thereto. For example, when the wind direction adjustment range is wide, or the like, the air-conditioning stop position may be a position within the wind direction adjustment range of the fins. The mode of the air-conditioning stop position can be changed according to design specifications.

In the embodiment, the example has been described in which the gap is a gap through which a sphere having a diameter of 5 mm or more cannot enter, but the present invention is not limited thereto. For example, in the case of a structure that prevents small foreign matter from entering, the gap does not need to be a gap that prevents a sphere with a diameter of 5 mm or more from entering. A side of the gap can be changed according to design specifications.

In the embodiment, the example has been described in which the fins in the air-conditioning outlet are configured in two axes, and the fins configured in two axes include the windward fins and the leeward fins that are disposed downstream in the wind direction from the windward fins, and the control unit performs the shut control and the air-conditioning stop control on the leeward fins, but the present invention is not limited thereto. For example, the plurality of fins may be configured in a single axis. The configuration of the fins can be changed according to the design specifications.

In the embodiment, the example has been described in which the plurality of fins are disposed at each of the plurality of air-conditioning outlets, but the present invention is not limited thereto. For example, a single fin may be disposed at each of the plurality of air-conditioning outlets. One or more fins may be disposed at at least some of the air-conditioning outlets. The number of fins disposed at each of the air-conditioning outlets can be changed according on design specifications.

In the embodiment, the example has been described in which the windward fins adjust the wind direction in the up-down direction and the leeward fins adjust the wind direction in the left-right direction in the air-conditioning outlet, but the present invention is not limited thereto. For example, the air-conditioning outlet may be configured so that the wind direction is adjusted in the left-right by the windward fins, and the wind direction is adjusted in the up-down by the leeward fins.

Further, in FIG. 3, the example has been described in which the fully closed position is a position at which the tip end portions of the fins 14 come into contact with the right side surface of the inner circumference of the duct 10, but the present invention is not limited thereto. For example, the fully closed position may be a position at which the tip end portions of the fins 14 come into contact with the left side surface of the inner circumference of the duct 10.

The air-conditioning air outlet device for a vehicle according to the embodiment has been described as including the air-conditioning outlet and the control unit that controls the air-conditioning outlet, but is not limited thereto. For example, the control unit may be provided in the air-conditioning outlet. For example, when the air-conditioning outlet includes the driving unit, the wind direction adjustment fins driven by the driving unit, and the control unit that controls the driving unit, and when wind blowing is stopped during operation of the air-conditioning of the vehicle, the control unit may also be configured to perform the shut control in which the fins are moved to the fully closed position, and the air-conditioning stop control in which the fins are moved to the air-conditioning stop position which is the position with a gap from the fully closed position, when the air-conditioning is stopped. The control unit may or may not be included in the air-conditioning outlet side. The configuration of the vehicle air-conditioning outlet device (the installation manner of the control unit) can be changed according to design specifications.

A program for realizing all or a part of the functions of the air-conditioning outlet device for a vehicle and the air-conditioning outlet of the present invention may be recorded on a computer-readable recording medium, and the program recorded on the recording medium may be read into a computer system and executed to perform all or a part of the processing performed by the air-conditioning outlet device for a vehicle and the air-conditioning outlet. The term “computer system” as used here includes hardware such as an OS and peripheral devices. The “computer system” also includes a WWW system equipped with a homepage provision environment (or display environment). Furthermore, the “computer-readable recording medium” refers to a portable medium such as flexible disks, magneto-optical disks, ROMs and CD-ROMs, as well as storage devices such as hard disks built into the computer system. Furthermore, “computer-readable recording medium” also includes a device that stores a program for a certain period of time, such as volatile memory (RAM) within a computer system that serves as a server or client when a program is transmitted via a network such as the Internet or a communication line such as a telephone line.

Furthermore, the program may be transmitted from a computer system in which a program is stored in a storage device or the like to another computer system via a transmission medium or by transmission waves in the transmission medium. Here, the “transmission medium” for transmitting the program refers to a medium having a function of transmitting information, such as a network (a communication network) such as the Internet or a communication line such as a telephone line. The program may also be one for realizing some of the above-described functions. Furthermore, the above-described functions may be realized in combination with a program already recorded in the computer system, that is, a so-called differential file (a differential program).

Although the embodiment of the present invention has been described above, but the present invention is not limited to such an embodiment, and various modifications and substitutions can be made within the scope that does not deviate from the gist of the present invention.

### Examples of aspects of the present invention are as follows

### Appendix 1

An air-conditioning outlet device for a vehicle includes:
at least one air-conditioning outlet; and
a control unit that controls the air-conditioning outlet,
wherein the air-conditioning outlet includes a driving unit and a wind direction adjustment fin that is driven by the driving unit, and
the control unit performs shut control to move the fin of the at least one air-conditioning outlet to a fully closed position when wind blowing is stopped during an operation of air-conditioning of the vehicle, and air-conditioning stop control to move the fins of all of the air-conditioning outlets to an air-conditioning stop position which is a position with a gap from the fully closed position when the air-conditioning is stopped.

### Appendix 2

The air-conditioning outlet device for a vehicle of Appendix 1 further includes a sealing member at a portion of the fin that faces the gap.

### Appendix 3

In the air-conditioning outlet device for a vehicle of Appendix 2, when the air-conditioning stop control is performed, the control unit moves the fins to the fully closed position to align them with origin positions, then moves them to the air-conditioning stop position, and then stops them.

### Appendix 4

In the air-conditioning outlet device for a vehicle of any one of Appendixes 1 to 3, the air-conditioning stop position is a position between a limit position on the side close to the fully closed position and the fully closed position within a wind direction adjustment range of the fins.

### Appendix 5

In the air-conditioning outlet device for a vehicle of any one of Appendixes 1 to 3, the gap is a gap that prevents spheres with a diameter of 5 mm or more from entering.

### Appendix 6

In the air-conditioning outlet device for a vehicle of any one of Appendixes 1 to 5, the fins are configured in two axes in the air-conditioning outlet,
the fins configured in two axes include windward fins and leeward fins disposed downstream of the windward fin in a wind direction, and
the control unit performs the shut control and the air-conditioning stop control on the leeward fins.

What is claimed is:

1. An air-conditioning outlet device for a vehicle, comprising:
at least one air-conditioning outlet; and
a control unit configured to control the air-conditioning outlet,
wherein the air-conditioning outlet includes a driving unit and a wind direction adjustment fin that is driven by the driving unit, and
the control unit performs shut control to move the fin of the at least one air-conditioning outlet to a fully closed position when wind blowing is stopped during an operation of air-conditioning of the vehicle, and air-conditioning stop control to move the fins of all of the air-conditioning outlets to an air-conditioning stop position which is a position with a gap from the fully closed position when the air-conditioning is stopped.

2. The air-conditioning outlet device for a vehicle of claim 1, further comprising a sealing member at a portion of the fin that faces the gap.

3. The air-conditioning outlet device for a vehicle of claim 2, wherein when the air-conditioning stop control is performed, the control unit moves the fins to the fully closed position to align them with origin positions, then moves them to the air-conditioning stop position, and stops them.

4. The air-conditioning outlet device for a vehicle of claim 3, wherein the air-conditioning stop position is a position between a limit position on a side close to the fully closed position and the fully closed position within a wind direction adjustment range of the fins.

5. The air-conditioning outlet device for a vehicle of claim 3, wherein the gap is a gap that prevents spheres with a diameter of 5 mm or more from entering.

6. The air-conditioning outlet device for a vehicle of claim 1, wherein the fins are configured in two axes in the air-conditioning outlet,
the fins configured in two axes include windward fins and leeward fins disposed downstream of the windward fin in a wind direction, and
the control unit performs the shut control and the air-conditioning stop control on the leeward fins.

7. The air-conditioning outlet device for a vehicle of claim 2, wherein the fins are configured in two axes in the air-conditioning outlet,
the fins configured in two axes include windward fins and leeward fins disposed downstream of the windward fin in a wind direction, and
the control unit performs the shut control and the air-conditioning stop control on the leeward fins.

8. The air-conditioning outlet device for a vehicle of claim 3, wherein the fins are configured in two axes in the air-conditioning outlet,
the fins configured in two axes include windward fins and leeward fins disposed downstream of the windward fin in a wind direction, and
the control unit performs the shut control and the air-conditioning stop control on the leeward fins.

9. The air-conditioning outlet device for a vehicle of claim 4, wherein the fins are configured in two axes in the air-conditioning outlet,
the fins configured in two axes include windward fins and leeward fins disposed downstream of the windward fin in a wind direction, and
the control unit performs the shut control and the air-conditioning stop control on the leeward fins.

10. The air-conditioning outlet device for a vehicle of claim 5, wherein the fins are configured in two axes in the air-conditioning outlet,
the fins configured in two axes include windward fins and leeward fins disposed downstream of the windward fin in a wind direction, and
the control unit performs the shut control and the air-conditioning stop control on the leeward fins.
